(19) United States
(12) Patent Application Publication
(10) Pub. No.: US 2021/0037789 A1
(43) Pub. Date: Feb. 11, 2021

(54) Slip Leash

(71) Applicant: Aften R. Owens, Dallas, TX (US)

(72) Inventor: Aften R. Owens, Dallas, TX (US)

(21) Appl. No.: 16/987,303

(22) Filed: Aug. 6, 2020

Related U.S. Application Data
(60) Provisional application No. 62/883,723, filed on Aug. 7, 2019.

(51) Int. Cl. A01K 27/00

(52) U.S. Cl. CPC A01K 27/003

(57) ABSTRACT

A slip leash is disclosed. In one embodiment, an adjustable cord stop receives a lead therethrough. A sleeve member is at one end. A sliding ring member is pivotally connected to the sleeve member. The sliding ring member has an opening for accepting the lead therethrough. The sliding ring member forms a slipping loop. The sliding ring member has first and second ring portions distally extending thereapart in a planar curve from the sleeve member. Third and fourth ring portions respectively converge from the first and second ring portions to an end portion and form a union therewith. The end portion of the sliding ring member forms a point. In use, the sliding ring member points to the handler to indicate the slip leash has been placed on the dog correctly.

### PRIORITY STATEMENT & CROSS-REFERENCE TO RELATED APPLICATIONS

This application claims the benefit of the Provisional U.S. Patent Application No. 62/883,723, entitled “Slip Leash” and filed on Aug. 7, 2019, in the name of Aften R. Owens; which is hereby incorporated by reference, in entirety, for all purposes.

### TECHNICAL FIELD OF THE INVENTION

This invention relates, in general, to leashes or leads and, in particular, to slip leashes often used in work, exercise, or competitions for controlling a dog with an adjustable, slipping loop that goes around the dog's neck.

### BACKGROUND OF THE INVENTION

Slip leashes are often used in work, exercise, or competitions for controlling a dog. A slip leash typically has a measure of rope or other material with a loop handle at one end and an adjustable, slipping loop with a sliding ring at the other end. The adjustable, slipping loop goes around the dog's neck and may be quickly removed and replaced. Although a slip leash may be quickly removed and replaced, to provide the most efficacy, the slip leash must be placed around the dog's neck in the appropriate manner to mitigate the chances of the sliding ring falling down to the middle of the neck. Accordingly, there is a need for improved slip leashes for ensuring proper placement around the dog's neck.

### SUMMARY OF THE INVENTION

It would be advantageous to achieve a slip leash that would improve upon existing limitations in functionality. It would be desirable to enable a mechanical-based solution that would provide enhanced convenience while ensuring proper placement of the slip leash around the dog's neck. To better address one or more of these concerns, a slip leash is disclosed. In one embodiment, an adjustable cord stop receives a lead therethrough. A sleeve member is at one end. A sliding ring member is pivotally connected to the sleeve member. The sliding ring member has an opening for accepting the lead therethrough. The sliding ring member forms a slipping loop. The sliding ring member has first and second ring portions distally extending thereapart in a planar curve from the sleeve member. Third and fourth ring portions respectively converge from the first and second ring portions to an end portion and form a union therewith. The end portion of the sliding ring member forms a point. In use, the sliding ring member points to the handler to indicate the slip leash has been placed on the dog correctly. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a front perspective view depicting one embodiment of a slip leash therewith according to the teachings presented herein;

FIG. 2 is a side elevation view of a portion of the slip leash presented in FIG. 1;

FIG. 3 is an elevation view along line 3-3 of FIG. 2;

FIG. 4 is an elevation view along line 4-4 of FIG. 2;

FIG. 5 is a top plan view of the slip leash presented in FIG. 1;

FIG. 6 is a side elevation view of the slip leash presented in FIG. 1; and

FIG. 7 is a rear perspective view of a dog wearing the slip leash presented in FIG. 1 in an operational embodiment according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

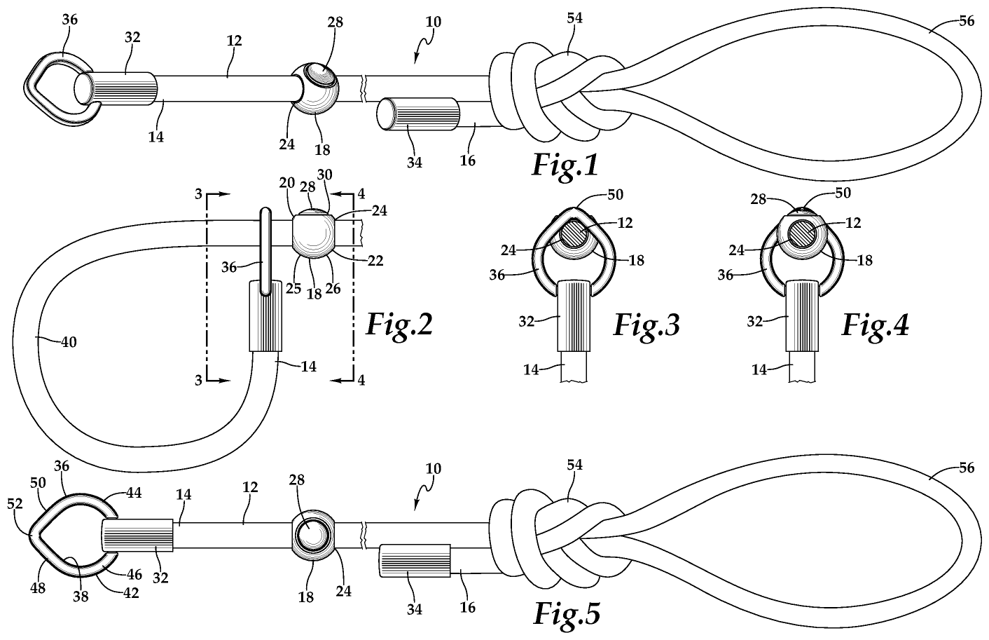

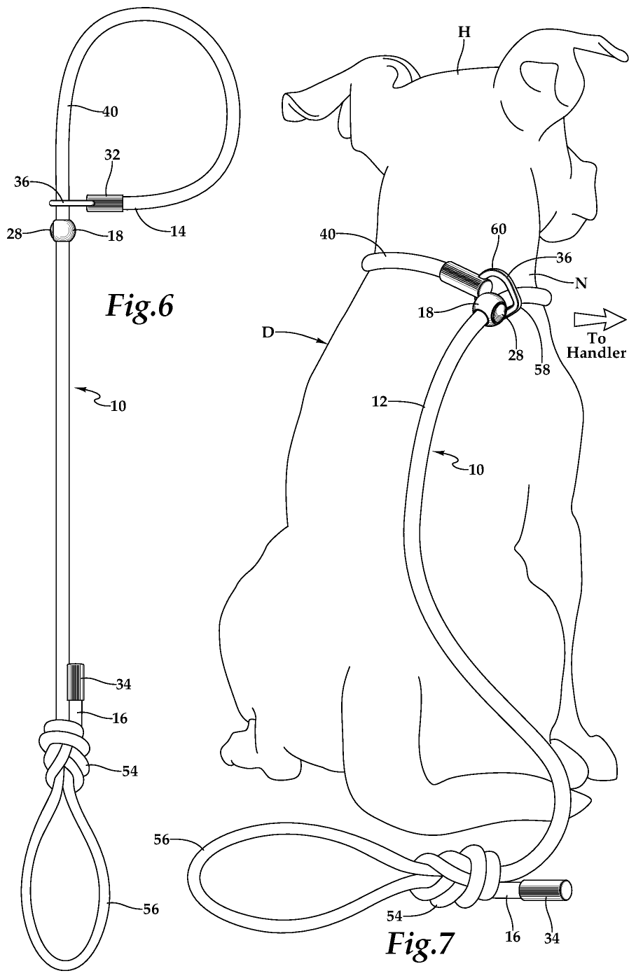

Referring initially to FIG. 1 through FIG. 6, therein is depicted one embodiment of a slip leash 10 according to the teachings presented herein. A lead 12 has ends 14, 16. The lead 12 may be made of rope or leather. In one embodiment, the lead includes kernmantle rope. An adjustable cord stop 18 receives the lead 12 therethrough. In one embodiment, the adjustable cord stop includes a body 20 having an exterior 22 and a channel 24 extending through an interior thereof. As shown, the exterior 22 of the body 20 is sized to provide a finger platform 25 component of a thumb-finger precision grip platform 26. A plunger 28 may be spring-mounted to the interior of the body 20. The plunger 28 is sized to provide a thumb platform 30 component of the thumb-finger precision grip platform 26. In operation, the lead 12 is adjustable through the body 20 when the plunger 28 is compressed and the lead 12 is locked when the plunger 28 is relaxed.

A sleeve member 32 is secured to the end 14 and a sleeve member 34 is secured to the second end 16. In one embodiment, a sliding ring member 36 is pivotally connected to the sleeve member 32. As shown in the illustrated embodiment, the sliding ring member 36 has an opening 38 therethrough and a slipping loop 40 is formed at the end 14. The slipping loop 40 excludes the adjustable cord stop 18. The sliding ring member 36 has first and second ring portions 42, 44 distally extending thereapart in a planar curve 46 from the sleeve member 32. The sliding ring member 36 also has third and fourth ring portions 48, 50 respectively converging from the first and second ring portions 42, 44 to an end portion 52 and forming a union therewith. As depicted, the end portion 52 of the sliding ring member 36 forms a point. In one embodiment, the sliding ring member 36 may be a teardrop shape.

In operation, the opening 38 of the sliding ring member 36 permits movement of the lead 12 therethrough. The opening 38, however, obstructs movement of the adjustable cord stop 18 therethrough. A variety of treatments may be found at the end 16. As shown, a figure-8 knot 54 is formed at the end 16. The figure-8 knot 54 provides a grab handle 56 and allows a handler of a dog utilizing the slip leash 10 to easily make a grab adjustment. A loop may be used in place of the figure-8 knot.

Referring now to FIG. 7, in operation, the slip leash 10 is very practical and may be quickly removed and replaced from a dog D. Initially, the slip leash 10 is prepared by creating a slipping loop 40 large enough to easily pass over a head H of the dog D to a neck N. Once the dog D is aware of the handler's presence, the slipping loop 40 is passed over the head H. Preferably, the slipping loop 40 is held at the sliding ring member 36 to prevent the slipping loop 40 from changing size when being placed on the dog D. The sliding ring member 36 points to the handler to indicate the slip leash 10 has been placed on the dog D correctly. In particular, an upper portion 58 of the sliding ring member 36 provides a visual indictor by, in one embodiment, the teardrop shape having an end pointing direction. With the slip leash 10 placed around the neck N of the dog D in the appropriate manner, the chances of the sliding ring member 36 falling down to the middle of the neck are mitigated. It should be understood that if the sliding ring member 36 points away from the handler, then the slip leash 10 was placed on the dog D backwards and the slip leash 10 should be reapplied.

With the sliding ring member 36 pointing to the handler, the size of the slipping loop 40 may be tightened by pulling on the second end 16 of the lead 12. The size of the slipping loop 40 is then secured by selectively and temporarily depressing the plunger 28 while sliding the adjustable cord stop 18 to the appropriate location toward the sliding ring member 36. The slip leash should not be too tight and ideally two fingers-width should fit between the neck N of the dog D and the slipping loop 40. The figure-8 shape knot 54 provides the grab handle 56 for the handler during use. As mentioned, the upper portion 58 of the sliding ring member 36 provides a visual indictor by, in one embodiment, the teardrop shape having the end pointing direction. Also, to improve use, a lower portion 60 of the sliding ring member 36 is conformed to the shape of the lead 12 to accommodate the lead 12 sliding through the sliding ring member 36. To remove the slip leash 10 from the dog D, again selectively and temporarily depress the plunger 28 while sliding the adjustable cord stop 18 toward the end 16 of the lead 12. Once the slipping loop 40 is enlarged and of sufficient size, the slipping loop 40 may be gently guided away from the neck N of the dog D, over the head H of the dog D, and removed. The slip leash 10 is then off the dog D.

The order of execution or performance of the methods and techniques illustrated and described herein is not essential, unless otherwise specified. That is, elements of the methods and techniques may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A slip leash comprising:
a lead having a first end and a second end;
an adjustable cord stop receiving the lead therethrough;
a first sleeve member secured to the first end;
a sliding ring member pivotally connected to the first sleeve member, the sliding ring member having an opening therethrough, the sliding ring member forming a slipping loop at the first end, the slipping loop excluding the adjustable cord stop;
the sliding ring member having first and second ring portions distally extending thereapart in a planar curve from the first sleeve member, the sliding ring member having third and fourth ring portions respectively converging from the first and second ring portions to an end portion and forming a union therewith;
the end portion of the sliding ring member forming a point;
the opening of the sliding ring member permitting movement of the lead therethrough; and
the opening of the sliding ring member obstructing movement of the adjustable cord stop therethrough.

2. The slip leash as recited in claim 1, wherein the lead further comprises a material selected from leather and rope.

3. The slip leash as recited in claim 1, wherein the lead further comprises kernmantle rope.

4. The slip leash as recited in claim 1, wherein the adjustable cord stop further comprises:
a body having an exterior and a channel extending through an interior thereof;
the exterior of the body sized to provide a finger platform component of a thumb-finger precision grip platform;
a plunger spring-mounted to the interior of the body, the plunger being sized to provide a thumb platform component of a thumb-finger precision grip platform;
the lead being adjustable through the body when the plunger is compressed; and
the lead being locked when the plunger is relaxed.

5. The slip leash as recited in claim 1, wherein the sliding ring member further comprises a teardrop shape.

6. The slip leash as recited in claim 1, further comprising a second sleeve member secured to the second end.

7. The slip leash as recited in claim 1, further comprising a loop at the second end.

8. The slip leash as recited in claim 1, further comprising a figure-8 knot formed at the second end.

9. A slip leash comprising:
a lead having a first end and a second end, the lead including kernmantle rope;
an adjustable cord stop receiving the lead therethrough, the adjustable cord stop including:
a body having an exterior and a channel extending through an interior thereof;
the exterior of the body sized to provide a finger platform component of a thumb-finger precision grip platform;
a plunger spring-mounted to the interior of the body, the plunger being sized to provide a thumb platform component of a thumb-finger precision grip platform;
the lead being adjustable through the body when the plunger is compressed; and
the lead being locked when the plunger is relaxed;
a first sleeve member secured to the first end;
a second sleeve member secured to the second end;
a sliding ring member pivotally connected to the first sleeve member, the sliding ring member having an opening therethrough, the sliding ring member forming a slipping loop at the first end, the slipping loop excluding the adjustable cord stop;
the sliding ring member having first and second ring portions distally extending thereapart in a planar curve from the first sleeve member, the sliding ring member having third and fourth ring portions respectively converging from the first and second ring portions to an end portion and forming a union therewith;
the end portion of the sliding ring member forming a point;
the opening of the sliding ring member permitting movement of the lead therethrough;
the opening of the sliding ring member obstructing movement of the adjustable cord stop therethrough; and
a figure-8 knot formed at the second end.

10. A slip leash comprising:
a lead having a first end and a second end;
an adjustable cord stop receiving the lead therethrough;
a sliding ring member pivotally connected to the first end, the sliding ring member having an opening therethrough, the sliding ring member forming a slipping loop at the first end, the slipping loop excluding the adjustable cord stop;
the sliding ring member being a teardrop shape;
the end portion of the sliding ring member forming a point;
the opening of the sliding ring member permitting movement of the lead therethrough; and
the opening of the sliding ring member obstructing movement of the adjustable cord stop therethrough.
